(19) United States
(12) Patent Application Publication
(10) Pub. No.: US 2021/0129778 A1
(43) Pub. Date: May 6, 2021

(54) ELECTRICAL ASSEMBLY

(71) Applicant: Lear Corporation, Southfield, MI (US)

(72) Inventors: Jose Gabriel Fernández Bañares, Valls (ES); Raúl Ricart, Valls (ES); Antoni Ferré Fàbregas, Valls (ES)

(21) Appl. No.: 16/672,989

(22) Filed: Nov. 4, 2019

(51) Int. Cl. B60R 16/03; B60N 2/90; B60N 2/08

(52) U.S. Cl. CPC B60R 16/03; B60N 2/08; B60N 2/90

(57) ABSTRACT

An electrical assembly includes a power converter, a track assembly, and a support assembly. The power converter may include a first portion and/or a second portion. The track assembly may be connected to the first portion. The support assembly may be selectively connectable to the track assembly, and/or the support assembly may include the second portion of the power converter. The support assembly may be configured to move along the track assembly. The first portion of the power converter may be configured to selectively electrically connect with the second portion of the power converter via the track assembly to provide power from a power source to the support assembly. The support assembly may include a locking member, and/or the locking member may be configured to selectively engage the track assembly to limit movement of the support assembly relative to the track assembly in at least one direction.

### TECHNICAL FIELD

The present disclosure generally relates to electrical assemblies, including electrical assemblies that may be used in connection with vehicles.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some electrical assemblies may be relatively complex and/or may not provide sufficient functionality. Some electrical assemblies may not be configured for use with vehicle support assemblies or removable or reconfigurable support assemblies, such as vehicle seats.

There is a desire for solutions/options that minimize or eliminate one or more challenges or shortcomings of electrical assemblies. The foregoing discussion is intended only to illustrate examples of the present field and is not a disavowal of scope.

### SUMMARY

In embodiments, an electrical assembly may include a power converter, a track assembly, and/or a support assembly. The power converter may include a first portion and/or a second portion. The track assembly may be connected to the first portion. The support assembly may be selectively connectable to the track assembly, and/or the support assembly may include the second portion of the power converter. The support assembly may be configured to move (e.g., selectively, such as when power is not supplied to the track assembly and/or the support assembly) along the track assembly. The first portion of the power converter may be configured to selectively electrically connect with the second portion of the power converter via the track assembly to provide power from a power source to the support assembly. The support assembly may include a locking member, and/or the locking member may be configured to selectively engage the track assembly to limit movement of the support assembly relative to the track assembly in at least one direction.

With embodiments, the track assembly may include a conductor, and/or the support assembly may include a contact. The contact may be configured to selectively engage the conductor to electrically connect the second portion of the power converter to the first portion of the power converter. The fist portion of the power converter may be configured to convert DC power from said power source to AC power and provide the AC power to the track assembly. The second portion of the power converter may be configured to convert AC power to DC power. The electrical assembly may include one or more additional support assemblies that may be configured for selective connection with and removal from the track assembly. A first additional support assembly of the one or more additional support assemblies may include a third portion of the power converter. The second portion may be configured to convert AC power to DC power. The third portion may be configured to convert AC power to DC power. The third portion may be configured differently than the second portion.

In embodiments, the second portion may be configured to provide DC power to an actuator of the support assembly, and/or the third portion may be connected to a DC power outlet of the first additional support assembly. The support assembly may include a vehicle seat and/or the actuator may include a seat motor. The first additional support assembly may include one or more AC outlets that may be configured for selective connection with the track assembly to provide AC power from the first portion of the power converter. A second additional support assembly of the one or more additional support assemblies may include an AC outlet and/or may not include a portion of the power converter.

With embodiments, a track assembly may include a recess, and/or the recess may be configured to at least partially receive a conductor that may be configured to provide an electrical connection between the first portion of the power converter and/or the second portion of the power converter. The track assembly may include a plurality of tracks that may be disposed substantially parallel with each other and/or may be connected to a mounting surface of a vehicle. The first portion may be configured to provide substantially the same AC power to each track of the plurality of tracks. The support assembly may include at least one rolling member that may be configured to roll along the track assembly. The support assembly may be configured to move vertically to disengage the track assembly.

In embodiments, an electrical assembly may include a track assembly, a support assembly, and/or a power converter including a first portion and/or a second portion. A method of operating an electrical assembly may include electrically connecting the support assembly to the track assembly. The method may include providing DC power from a power source to the first portion of the power converter. The method may include converting the DC power to AC power via the first portion of the power converter; converting the DC power to AC power via the first portion of the power converter; and/or providing AC power from the first portion of the power converter to the support assembly via the track assembly. The method may include converting the AC power to DC power via the second portion of the power converter, and/or providing the DC power to a DC outlet and/or an actuator of the support assembly.

With embodiments, the method may include providing AC power from the first portion of the power converter to a plurality of additional support assemblies. A first additional support assembly of the plurality of additional support assemblies may include a third portion of the power converter that may be configured to convert the AC power to DC power. A first AC power outlet may be configured for connection with the track assembly, and/or a DC power outlet may be connected to an output of the third portion of the power converter. A second additional support assembly of the plurality of additional support assemblies may include a second AC power outlet that may be configured for connection with the track assembly.

In embodiments, a method of operating an electrical assembly may include providing the AC power from the first portion of the power converter to a plurality of additional support assemblies. The plurality of additional support assemblies may include a third additional support assembly that may include a fourth portion of the power converter. A fourth additional support assembly may include a fifth portion of the power converter, and/or a fifth additional support assembly may include a sixth portion of the power converter. The support assembly may include a first vehicle seat; the third additional support assembly may include a second vehicle seat; the fourth additional support assembly may include a third vehicle seat; and/or the fifth additional support assembly may include a fourth vehicle seat.

With embodiments, a second additional support assembly may not include a converter configured to convert the AC power from the first portion of the DC power. The first portion of the power converter may be connected to the second portion of the power converter via at least one conductor that may be disposed in the track assembly. The method may include providing AC power to an AC outlet of the support assembly. The first portion and/or the second portion of the power converter may cooperate to function as a DC/DC converter.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1A is a side view generally illustrating an embodiment of an electrical assembly according to teachings of the present disclosure.

FIG. 1B is a side view generally illustrating an embodiment of an electrical assembly according to teachings of the present disclosure.

FIG. 2 is a section view generally illustrating portions of an embodiment of an electrical assembly according to teachings of the present disclosure.

FIG. 3 is a top view generally illustrating an embodiment of an electrical assembly according to teachings of the present disclosure.

FIG. 4 is a flowchart generally illustrating an embodiment of a method of operating an electrical assembly according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they do not intended to limit the present disclosure to these embodiments and/or examples. On the contrary, the present disclosure covers alternatives, modifications, and equivalents.

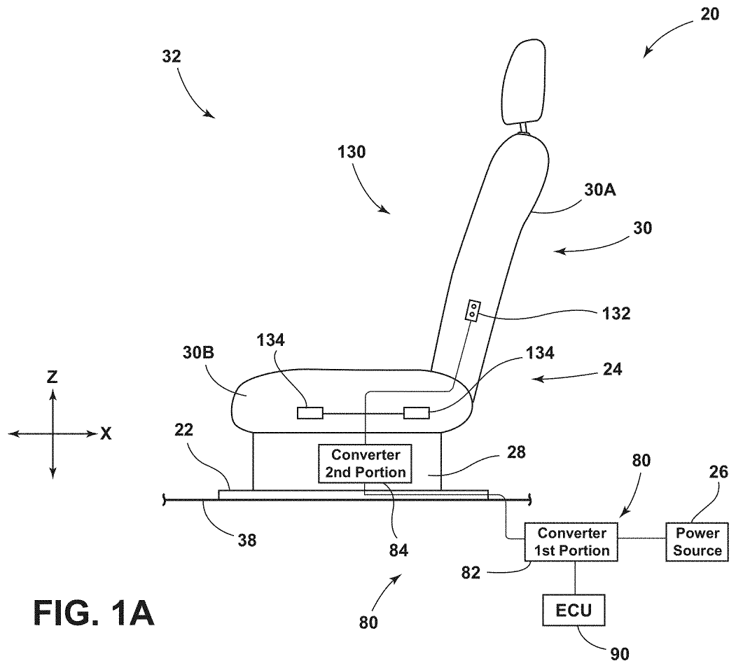

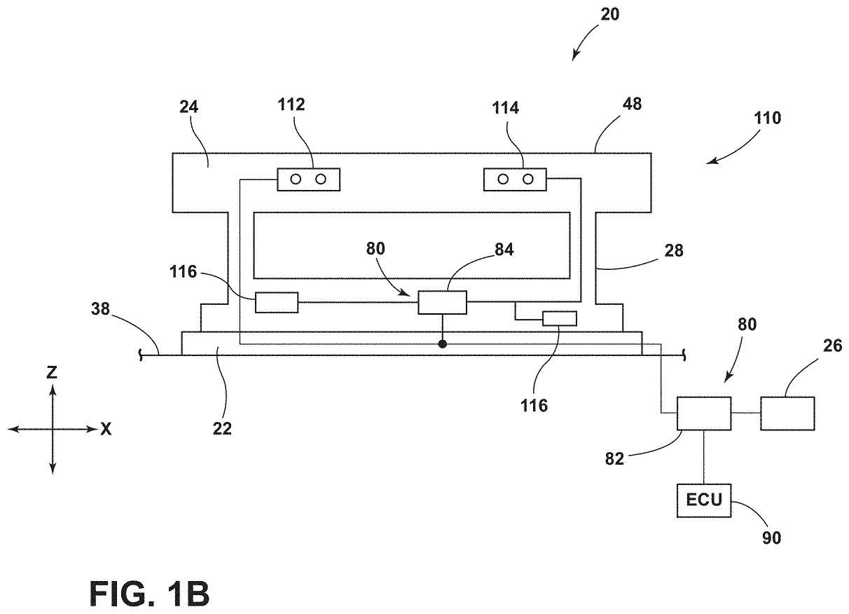

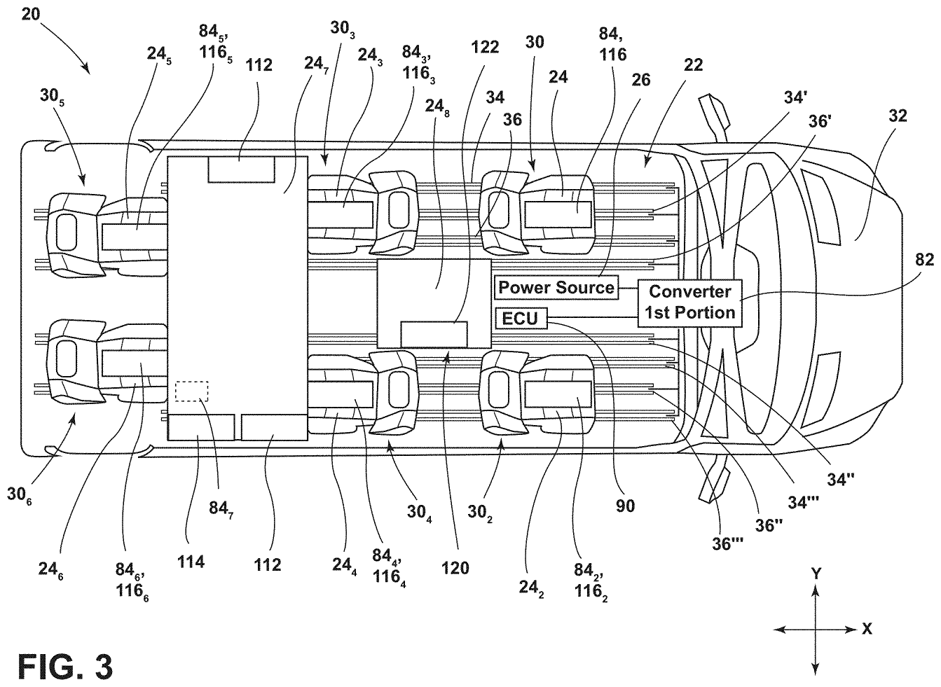

In embodiments, such as generally illustrated in FIGS. 1A and 1B, an electrical assembly 20 may include a track assembly 22, a support assembly 24, and/or a power source 26. The support assembly 24 may include a support member 28 that may be configured to support one or more other components, such as a seat 30, a support surface 110 (see, e.g., FIG. 1B), and/or a console 120 (see, e.g., FIG. 3), among others. The support member 28 may be configured to move (e.g. slide, roll, translate, etc.) along the track assembly 22. The electrical assembly 20 may be disposed within and/or be connected to a vehicle 32. The power source 26 may be configured to supply power to the support assembly 24 via the track assembly 22. A power source 26 may, for example and without limitation, include a vehicle battery, which may be configured to provide high voltage power, such as at least about 12 VDC, 24 VDC, 48 VDC, 400 VDC, and/or 800 VDC. A power converter 80 may be connected to the power source 26 and may be configured to convert power from the power source 26. For example and without limitation, the power converter 80 may be configured to convert direct current (DC) power of the power source 26 to alternating current (AC) power and/or to step up or down DC power. The power converter 80 may include a first portion 82 that may be substantially fixed relative to the track assembly 22 and a second portion 84 that may be connected to move with the support assembly 24.

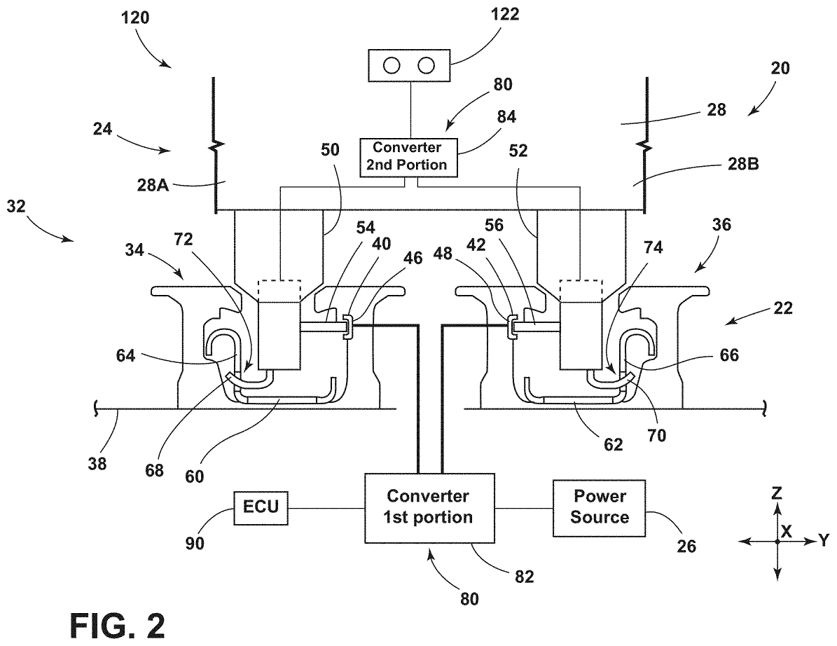

With embodiments, such as generally illustrated in FIG. 2, the electrical assembly 20 may include a track assembly 22. The track assembly 22 may include a first track 34 and/or a second track 36. The first track 34 and/or the second track 36 may be disposed on and/or connected to a mounting surface 38 (e.g., a floor of a vehicle 32). The first track 34 and/or the second track 36 may extend substantially in the X-direction. The first track 34 may be substantially parallel to the second track 36, and/or the first track 34 maybe offset in the Y-direction from the second track 36. The support assembly 24 may mechanically and/or electrically connect to the first track 34 and/or the second track 36.

In embodiments, such as generally illustrated in FIG. 2, the first track 34 and/or the second track 36 may be electrically connected to a power source 26 and/or a first portion 82 of a power converter 80. The first track 34 may include a first conductor 40 and/or the second track 36 may include a second conductor 42. One or both of the conductors 40, 42 may be electrically connected to the power source 26, such as via the first portion 82 of the power converter 80. The conductors 40, 42 may, for example, be disposed within a portion of a side of the first track 34 and/or the second track 36. The tracks 34, 36 may include recesses/apertures 46, 48 that may be configured to at least partially receive the conductors 40, 42. The conductors 40, 42 may electrically connect to the support assembly 24 and/or various electrical components within or associated with the support assembly 24. The conductors 40, 42 may be configured to provide power from the power source 26 and/or the first portion 82 of the power converter 80 to the support assembly 24 via the track assembly 22.

With embodiments, the support member 28 may be configured to support a seat 30 and/or one or more items or components that may be disposed on or connected support assembly 24, such as a seat 30, a support surface 110, a console 120 and/or one or more of a variety of accessories (e.g., vehicle accessories). In examples, a support member 28 may be separate from or integral with a supported component, such as a seat 30, a support surface 110, and/or a console 120. A seat 30 may include a seat back 30A and/or a seat base 30B (see, e.g., FIG. 1A). The support member 28 may be configured to be selectively inserted into and/or selectively removed from the track assembly 22, such as in the Z-direction. The support member 28 may be configured to move along the track assembly 22 substantially in the X-direction. The support assembly 24 may include a first rolling member 50 and/or a second rolling member 52 may that may be configured to facilitate movement of the support assembly 24 along the track assembly 22 (see, e.g., FIG. 2). The rolling members 50, 52 may be configured to contact an outer surface (e.g., top surface) of the first track 34 and/or the second track 36 as the support member 28 moves along the track assembly 22. The first rolling member 50 may be disposed substantially proximate a first portion 28A of the support member 28 and/or the second rolling member 52 may be disposed substantially proximate a second portion 28B of the support member 28.

In embodiments, the first portion 28A and/or the second portion 28B of the support member 28 may be disposed opposite each other (e.g., offset in the Y-direction) and may be configured for connection with the first track 34 and/or the second track 36. For example and without limitation, the first portion 28A may be connected to the first track 34 and the second portion 28B may be connected to the second track 36. Additionally or alternatively, the first portion 28A may be connected to the second track 36 and the second portion 28B may be connected to the first track 34 (e.g., the support assembly 24 may be configured for connection with the track assembly 22 in a plurality of configurations/orientations). The first portion 28A may include a first contact 54 and/or the second portion 28B may include a second contact 56. The contacts 54, 56 may be configured for electrical connection with respective conductors 40, 42 of the first track 34 and the second track 36. For example, if the support assembly 24 is connected with the track assembly 22 in a first direction (e.g., facing the front of a vehicle 32), the first contact 54 of the first portion 28A may electrically connect with the first conductor 40 of the first track 34, and the second contact 56 of the second portion 28B may electrically connect with the second conductor 42 of the second track 36. Additionally or alternatively, if the support assembly 24 is connected with the track assembly 22 in a second direction (e.g., facing a rear of a vehicle 32), the first contact 54 of the first portion 28A may electrically connect with the second conductor 42 of the second track 36, and the second contact 56 of the second portion 28B may electrically connect with the first conductor 40 of the first track 34.

With embodiments, the contacts 54, 56 of the support member 28 may be movably connected with the support member 28. For example and without limitation, the contacts 54, 56 may move (e.g., rotate, translate, etc.) into engagement with the conductors 40, 42 to facilitate an electrical connection with the track assembly 22 and may be configured to move out of engagement with the conductors 40, 42 to facilitate insertion/removal of the support assembly 24 into/from the track assembly 22 (e.g., in the Z-direction).

In embodiments, such as generally illustrated in FIG. 2, the track assembly 22 may include a first inner track 60 and/or a second inner track 62. The first inner track 60 may be substantially disposed within the first track 34, and/or the second inner track 62 may be substantially disposed within the second track 36. The first inner track 60 and/or the second inner track 62 may be in contact with a bottom portion of the first track 34 and/or the second track 36. The first inner track 60 and/or the second inner track 62 may include a first flange 64 and/or a second flange 66 that may extend substantially in the Z-direction. The first inner track 60 and/or the second inner track 62 may be substantially U-shaped. The support assembly 24 may include a first locking member 68 and/or a second locking member 70. The first locking member 68 may be configured to move (e.g., rotate, translate, etc.) into and out of engagement with one of a first plurality of apertures 72 of the first inner track 60. The second locking member 70 may be configured to move (e.g., rotate, translate, etc.) into and out of engagement with one of a second plurality of apertures 74 of the second inner track 62. Engagement between the first locking member 68 and the first plurality of apertures 72 may limit movement in at least one direction of the support assembly 24 with respect to the track assembly 22. Engagement between the second locking member 70 and the second plurality of apertures 74 may limit movement in at least one direction of the support assembly 24 with respect to the track assembly 22. For example and without limitation, the locking members 68, 70 may limit movement of the support assembly 24 in the Z-direction and/or the X-direction.

In embodiments, such as generally illustrated in FIGS. 1A, 1B, and 2, a first portion 82 of a power converter 80 (e.g., a distributed power converter) may be connected to and/or incorporated with a track assembly 22. The first portion 82 of the power converter 80 may be electrically connected (e.g., directly and/or indirectly) to the power source 26. The first portion 82 of the power converter 80 may be configured to receive power from the power source 26 and/or transmit/regulate power to the conductors 40, 42 of the first track 34 and/or the second track 36. For example and without limitation, the power source 26 may be configured to provide DC power to the first portion 82 of the power converter 80. The first portion 82 of the power converter 80 may be configured to convert DC power from the power source 26 to AC power and provide the AC power to the track assembly 22 (e.g., may be configured as a DC/AC converter). The first portion 82 of the power converter 80 may be configured to step-down (e.g., decrease) the voltage of the power source 26. For example and without limitation, the power source 26 may provide high voltage DC power (e.g., about 400 VDC or more or less) and the first portion 82 may be configured to convert the high voltage DC power to lower voltages (e.g., safe voltages such as at or below 50V at 50 Hz AC power and/or 75 VDC). The voltage potential at the power source 26 may be greater than the voltage potential at the conductors 40, 42 of the track assembly 22. The first portion 82 of the power converter 80 may be configured to reduce the voltage of the power source 26 such that lower power may be provided to the track assembly 22 and/or to the support assembly 24, such as for electronic accessories and/or appliances that may be connected to the support assembly 24 that may operate with voltages lower than the power source 26. Additionally or alternatively, the power converter 80 may be configured in one or more various ways to step-up power and/or increase the voltage supplied from the power source 26 (e.g., the first portion 82 and/or the second portion 84 of the power converter 80 may be configured to increase voltage provided by the power source 26). The electrical assembly 20 may include an ECU 90 (electronic control unit) that may be configured to control the first portion 82 of the power converter 80. For example and without limitation, the ECU 90 may be configured to monitor the status of the first portion 82 of the power converter 80 and/or ECU 90 may be configured to disconnect or deactivate the first portion 82 of the power converter 80 if an error is detected.

With embodiments, the first portion 82 of the power converter 80 may be disposed substantially proximate the track assembly 22. For example and without limitation, the first portion 82 of the power converter 80 may be disposed on the mounting surface 38 proximate the track assembly 22 or may be disposed (e.g., fixed) elsewhere in a vehicle 32. The first portion 82 of the power converter 80 may be disposed at a sufficient distance and/or may be sufficiently shielded from the track assembly 22 to limit interference (e.g., mechanical and/or electrical) that may be associated with normal operation of the support assembly 24 and/or the vehicle 32.

In embodiments, such as generally illustrated in FIGS. 1A, 1B, and 2, an electrical assembly 20 may include one or more additional portions of a power converter 80, such as a second portion 84. The second portion 84 of the power converter 80 may be connected to and/or substantially disposed within the support assembly 24 and/or the support member 28. The second portion 84 of the power converter 80 may be electrically connected (e.g., directly and/or indirectly) to the first portion 82 of the power converter 80. For example and without limitation, the second portion 84 of the power converter 80 may be connected to the first portion 82 of the power converter 80 via the track assembly 22 (e.g., via the conductors 40, 42 and/or the contacts 54, 56). The second portion 84 of the power converter 80 may be configured to step-down (e.g., reduce) the power from the first portion 82 of the power converter 80. Additionally or alternatively, the second portion 84 of the power converter 80 may be configured to convert the power provided by the first portion 82 of the power converter 80 (e.g., AC power) to DC power. The second portion 84 of the power converter 80 may be configured to convert the AC power from the first portion 82 to DC power and provide the DC power to DC devices of the support assembly 24. DC devices may, for example and without limitation, include components that may be used by occupants within the vehicle 32, such as one or more actuators 116 (e.g., seat motors, massage units, etc.) and/or DC power outlets 114, 132.

In embodiments, such as generally illustrated in FIG. 3, the electrical assembly 20 may include one or more support assemblies 24_{N}, such as the support assembly 24 and one or more additional support assemblies (e.g., support assemblies 24₂, 24₃, 24₄, 24₅, 24₆, 24₇, 24₈), which may be removably connected to the track assembly 22. The track assembly 22 may include a plurality of tracks (e.g., tracks 34, 36, 34′, 36′, 34″, 36″, 34″, 36′″) that may be configured for connection with the support assemblies 24_{N}. In examples, the first portion 82 of the power converter 80 may be configured to provide substantially the same power to each pair of tracks 34, 36; 34′, 36′; 34″, 36″; 34′″, 36′″. The one or more additional support assemblies 24_{N} may or may not be configured in the same or a similar manner as the support assembly 24.

In embodiments, such as generally illustrated in FIG. 3, one or more support assemblies (e.g., support assemblies 24, 24₂, 24₃, 24₄, 24₅, 24₆) may include a respective seat 30, 30₂, 30₃, 30₄, 30₅, 30₆, a respective additional portion 84, 84₂, 84₃, 84₄, 84₅, 84₆ of the power converter 80, and/or one or more actuators 116, 116₂, 116₃, 116₄, 116₅, 116₆.

Additionally or alternatively, with examples, one or more support assemblies (e.g., support assembly 24₇) may include a support surface 110 (e.g., a table), an additional portion 84₇ of the power converter 80, one or more AC outlets 112 that may be connected to the first portion 82 of the power converter 80 (e.g., via the track assembly 22), and/or one or more DC outlets 114 that may be connected to the portion 84₇ of the power converter 80. The portion 84₇ of the power converter 80 may include a different configuration than the second portion 84. For example and without limitation the second portion 84 may be configured to provide a first voltage (e.g., about 12 VDC for an actuator 116) and/or the additional portion 84₇ may be configured to provide a second voltage (e.g., about 5 VDC for an outlet 114). An AC outlet 112 may provide access to AC power, such as for a variety of electrical accessories that may be used in a vehicle 32 by an occupant (e.g., 110 V accessories). A DC outlet 114 may provide access to DC power to a variety of electrical accessories that may be used in the vehicle 32 by an occupant (e.g., USB-powered accessories).

With examples, one or more support assemblies (e.g., support assembly 24₈) may include a console 120 and/or one or more AC outlets 122 that may be connected to the first portion 82 of the power converter 80, such as via the track assembly 22 (e.g., tracks 36′, 34″). In examples, the support assembly 24₈ may not include a portion of the power converter 80. For example and without limitation, AC power may be provided substantially directly (e.g., via the track assembly 22 and without additional conversion) from the first portion 82 of the power converter 80 to the one or more AC outlets 122.

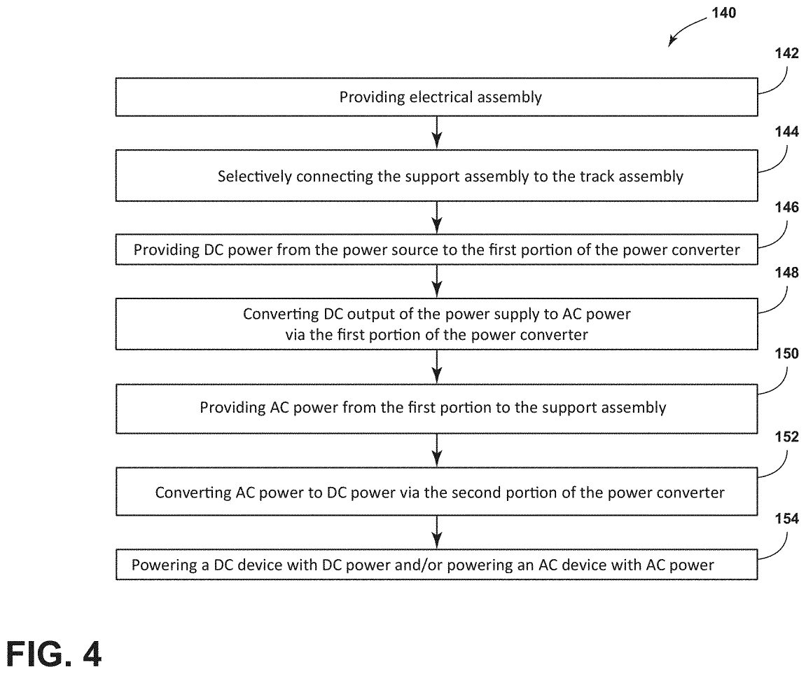

With embodiments, an electrical assembly 20 may include a track assembly 22, a support assembly 24, a power source 26, a first portion 82 of a power converter 80, and/or a second portion 84 of the power converter 80. The power source 26 may be electrically connected to the first portion 82 of the power converter 80. The first portion 82 of the power converter 80 may be electrically connected to the track assembly 22. As generally illustrated in FIG. 4, a method 140 of operating an electrical assembly 20 may include providing an electrical assembly 20 (step 142). The method 140 may include electrically connecting the support assembly 24 (e.g. the second portion 84 of the power converter 80) to the track assembly 22 (e.g., the first portion 82 of the power converter 80) (step 144). The method 140 may include providing DC power from the power source 26 to the first portion 82 of the power converter 80 (step 146). The method 140 may include stepping down and/or converting (e.g., from DC to AC) the output of the power source 26 via the first portion 82 of the power converter 80 (step 148). The method 140 may include providing AC power from the first portion 82 of the power converter 80 to the support assembly 24, such as via the track assembly 22 (step 150). The method 140 may include converting the AC power to DC power via the second portion 84 of the power converter 80 (step 152). The method 140 may include operating/powering a DC actuator with DC power and/or providing AC power to an AC device (e.g., an AC outlet 112, 122) (step 154).

In embodiments, a method 140 of operating an electrical assembly 20 may include providing AC power to a plurality of additional support assemblies 24_{N}. The plurality of additional support assemblies 24_{N} may include a first additional support assembly (e.g., support assembly 24₇) that may include another portion 84₇ (e.g., a third portion) of the power converter 80, an AC power outlet 112 configured for connection with the track assembly 22, and/or a DC power outlet 114 connected to the third portion 84₇ of the power converter 80. Additionally or alternatively, the plurality of additional support assemblies 24_{N} may include a second additional support assembly (e.g., support assembly 24₈) that may include a second AC power outlet 122 configured for connection (e.g., effectively a direct connection) with the track assembly 22.

With examples of electrical assemblies 20, a distributed power converter (e.g., power converter 80) may be more efficient than other designs. For example, some other designs may provide use a first DC/DC converter to step-down voltage from a power source and provide that stepped-down DC voltage to a track assembly. Then, some or all components connected to such a track assembly may include respective DC/DC converters to further step-down the voltage and/or may include respective DC/AC converters to provide AC power. Such configurations may include significantly more converter hardware, may be less energy efficient, and/or may involve providing more power to a track assembly, which may, for example, increase the risk of sparking and/or arcing.

In embodiments, an ECU (e.g., ECU 90) may include an electronic controller and/or include an electronic processor, such as a programmable microprocessor and/or microcontroller. In embodiments, an ECU may include, for example, an application specific integrated circuit (ASIC). An ECU may include a central processing unit (CPU), a memory (e.g., a non-transitory computer-readable storage medium), and/or an input/output (I/O) interface. An ECU may be configured to perform various functions, including those described in greater detail herein, with appropriate programming instructions and/or code embodied in software, hardware, and/or other medium. In embodiments, an ECU may include a plurality of controllers. In embodiments, an ECU may be connected to a display, such as a touchscreen display.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. An electrical assembly, comprising:
a power converter including a first portion and a second portion;
a track assembly connected to the first portion; and
a support assembly selectively connectable to the track assembly, the support assembly including the second portion of the power converter;
wherein the support assembly is configured to move along the track assembly; and the first portion of the power converter is configured to selectively electrically connect with the second portion of the power converter via the track assembly to provide power from a power source to the support assembly.

2. The electrical assembly of claim 1, wherein the support assembly includes a locking member; the locking member is configured to selectively engage the track assembly to limit movement of the support assembly relative to the track assembly in at least one direction; the track assembly includes a conductor; the support assembly includes a contact; and the contact is configured to selectively engage the conductor to electrically connect the second portion of the power converter to the first portion of the power converter.

3. The electrical assembly of claim 1, wherein the first portion of the power converter is configured to convert DC power from said power source to AC power and provide the AC power to the track assembly.

4. The electrical assembly of claim 3, wherein the second portion of the power converter is configured to convert AC power to DC power.

5. The electrical assembly of claim 1, including one or more additional support assemblies configured for selective connection with and removal from the track assembly.

6. The electrical assembly of claim 5, wherein a first additional support assembly of the one or more additional support assemblies includes a third portion of the power converter; the second portion is configured to convert AC power to DC power; the third portion is configured to convert AC power to DC power; and the third portion is configured differently than the second portion.

7. The electrical assembly of claim 6, wherein the second portion is configured to provide DC power to an actuator of the support assembly; and the third portion is connected to a DC power outlet of the first additional support assembly.

8. The electrical assembly of claim 7, wherein the support assembly includes a vehicle seat and the actuator includes a seat motor.

9. The electrical assembly of claim 6, wherein the first additional support assembly includes one or more AC outlets configured for selective connection with the track assembly to provide AC power from the first portion of the power converter.

10. The electrical assembly of claim 9, wherein a second additional support assembly of the one or more additional support assemblies includes an AC outlet and does not include a portion of the power converter.

11. The electrical assembly of claim 1, wherein the track assembly includes a recess; and the recess is configured to at least partially receive a conductor configured to provide an electrical connection between the first portion of the power converter and the second portion of the power converter.

12. The electrical assembly of claim 1, wherein the track assembly includes a plurality of tracks disposed substantially parallel with each other and connected to a mounting surface of a vehicle; and the first portion is configured to provide substantially the same AC power to each track of the plurality of tracks.

13. The electrical assembly of claim 1, wherein the support assembly includes at least one rolling member configured to roll along the track assembly; and the support assembly is configured to move vertically to disengage the track assembly.

14. A method of operating an electrical assembly comprising a track assembly, a support assembly, a power converter having a first portion and a second portion, the method comprising:
electrically connecting the support assembly to the track assembly;
providing DC power from a power source to the first portion of the power converter;
converting the DC power to AC power via the first portion of the power converter;
providing AC power from the first portion of the power converter to the support assembly via the track assembly;
converting the AC power to DC power via the second portion of the power converter; and
providing the DC power to a DC outlet and/or an actuator of the support assembly.

15. The method of claim 14, including providing the AC power from the first portion of the power converter to a plurality of additional support assemblies; wherein a first additional support assembly of the plurality of additional support assemblies includes a third portion of the power converter configured to convert the AC power to DC power, a first AC power outlet configured for connection with the track assembly, and a DC power outlet connected to an output of the third portion of the power converter; and a second additional support assembly of the plurality of additional support assemblies includes a second AC power outlet configured for connection with the track assembly.

16. The method of claim 14, including providing the AC power from the first portion of the power converter to a plurality of additional support assemblies; wherein the plurality of additional support assemblies includes a third additional support assembly including a fourth portion of the power converter, a fourth additional support assembly including a fifth portion of the power converter, and a fifth additional support assembly including a sixth portion of the power converter; the support assembly includes a first vehicle seat; the third additional support assembly includes a second vehicle seat; the fourth additional support assembly includes a third vehicle seat; and the fifth additional support assembly includes a fourth vehicle seat.

17. The method of claim 15, wherein the second additional support assembly does not include a converter configured to convert the AC power from the first portion to DC power.

18. The method of claim 14, wherein the first portion of the power converter is connected to the second portion of the power converter via at least one conductor in the track assembly.

19. The method of claim 14, providing the AC power to an AC outlet of the support assembly.

20. The method of claim 14, wherein the first portion and the second portion of the power converter cooperate to function as a DC/DC converter.
